(19) United States
(12) Patent Application Publication
(10) Pub. No.: US 2016/0082891 A9
(43) Pub. Date: Mar. 24, 2016

(54) Waterproof container for being releasably carried on the exterior of a lockable closure of a police vehicle

(71) Applicant: Eric C. Parks, Mayfield Heights, OH (US)

(72) Inventor: Eric C. Parks, Mayfield Heights, OH (US)

(21) Appl. No.: 13/986,993

(22) Filed: Jun. 21, 2013

Related U.S. Application Data
(60) Provisional application No. 61/690,405, filed on Jun. 26, 2012.

(51) Int. Cl. B60R 7/08

(52) U.S. Cl. CPC B60R 7/08

(57) ABSTRACT

A waterproof container is provided for collecting, securely enclosing, transporting and storing pocket contents, personal possessions, weapons, contraband, evidence and other paraphernalia collected from a person of interest who has been stopped or is being detained, frisked, questioned or arrested. A base structure underlies and supports the container. A snap-together connection releasably attaches the container to the base structure. Magnetic material and a hook formation preferably are provided to hold the base structure in place on the exterior of a lockable closure of a police vehicle, typically on a trunk lid of the vehicle.

### REFERENCE TO PROVISIONAL APPLICATION

The present application claims the benefit of the filing date of a provisional application Ser. No. 61/690,405 filed Jun. 26, 2012 by Eric C. Parks entitled WATERPROOF CONTAINER RELEASABLY LOCKABLE TO A POLICE VEHICLE, the disclosure of which is incorporated herein by reference.

### BACKGROUND

The present invention relates to the provision and use of waterproof containers intended to be releasably coupled, one at a time, to an underlying base structure that is carried on the exterior of a lockable closure of a police vehicle, such as a trunk lid. Each container is preferably used to receive and retain items collected from a different person of interest. A snap-together connection is preferably provided for releasably coupling the containers, one at a time, to the base structure.

U.S. Pat. No. 6,401,994 issued Jun. 11, 2002 to Ham et al recognizes the utility of providing a trunk-lid-mounted container on the exterior of a police vehicle to store and transport such items as weapons, contraband and evidence gathered from a crime scene, or consisting of the personal property of a person being taken into custody.

Another proposal advanced in published U.S. application 2008/0277309 of Ronald C. Balla relates to a tray designed to be permanently affixed to an external surface a police vehicle. The tray of Balla is provided with individually lidded compartments for containing items collected from a person of interest.

### SUMMARY

In one respect, the present invention relates to a waterproof container that is well suited to receive and retain such items as may be collected by a police officer from a person of interest who has been stopped or is being detained, frisked, questioned or arrested.

In another respect, the present invention relates to a base structure that is well suited to be carried on the exterior of a lockable closure of a police vehicle (typically a trunk lid) to underlie and support, one at a time, a sequence of waterproof containers that each are used to receive and retain items collected from a different person of interest, with a snap-together connection preferably being provided to releasably couple the containers, one at a time, to the base structure.

In preferred practice, the present invention relates to the combination of 1) a waterproof container that is well suited to receive and retain items collected from a person of interest, 2) a base structure that is well suited to be carried on the exterior of a lockable closure (typically a trunk lid) of a police vehicle, and 3) a snap-together connection for releasably coupling the container to the base structure.

Also within the purview of the invention is a method of utilizing a series of waterproof containers to receive and retain items collected from a series persons of interest by using the containers, one at a time, while they are releasably snap-connected to a base structure supported on the exterior of a lockable closure, typically a trunk lid of a police vehicle.

In some embodiments, the waterproof container and the base structure are provided with interfitting formations that cooperate to provide a snap-together connection that permits a sequence of substantially identical containers to be quickly and easily coupled to and removed from the base structure.

In some embodiments the base structure has a central region well suited to underlie and support, one at a time, a sequence of substantially identical waterproof containers that are used to receive and retain items collected from persons of interest, with spaced upstanding formations located on opposite sides of central region of the base structure extending into recesses defined by opposed, upstanding end walls of each of the containers to provide snap-together connections that can be quickly and easily released from holding an in-use container so it can be replaced by a substantially identical ready-to-use container.

In some embodiments a bottom surface of the central region of the base structure has magnetic material attached or adhered thereto that helps to hold the base structure in place on the exterior of a lockable closure of a vehicle.

In some embodiments the base structure includes a hook formation configured to extend around an edge portion of a trunk lid or other lockable closure on which the base structure is carried to help retain the base structure in place on the closure.

In some embodiments the base structure further includes an elongate strap having one end region attached to the hook formation, with the strap being well suited to extend into an interior region of a trunk of a police vehicle for connection to an interior portion of the trunk lid to help retain the base structure in place on the exterior of the trunk lid.

### BRIEF DESCRIPTION OF THE DRAWINGS

A fuller understanding of the present invention may be had by referring to the description and claims that follow, taken in conjunction with the accompanying drawings, wherein:

FIG. 1 is a perspective view showing a rear portion of a police vehicle having a lockable closure in the form of a trunk lid, and showing one preferred form of a waterproof container embodying features of the present invention positioned atop the trunk lid near an edge region thereof and adjacent a left rear fender of the vehicle;

FIG. 2 is an enlarged perspective view of the waterproof container of FIG. 1 positioned atop the edge region of the trunk lid and adjacent the left rear fender of the vehicle, with the view showing a hinged lid of the container in an open position, and showing internal compartments of the container, some of which have hinged lids that also are shown in open positions;

FIG. 3 is an enlarged cross-sectional view as seen from a plane indicated by a line 3-3 in FIG. 2 illustrating how the container is provided with a hook formation configured to extend around an edge of the trunk lid to help hold the container in place on the trunk lid;

FIG. 4 is a perspective view showing front, top and right side portions of another preferred form of waterproof container carried on a base structure positioned atop an exterior surface of a trunk lid of a police vehicle, with the container having its lid in a closed position, and with the view showing elements of a snap-together connection that releasably attaches the container to the base structure, including an upstanding right end formation of the base structure that is received in a recess defined by an upstanding right end wall of the container;

FIG. 5 is a perspective view taken from a different vantage point, showing the waterproof container, the trunk lid and the rear vehicle portion of FIG. 4, with the lid of the container pivoted to an open position permitting interior portions of the container to be seen, and with the view showing an upstanding left end formation of the base structure extending into a recess defined by an upstanding left end wall of the container that also provide elements of the snap-together connection;

FIG. 6 is an exploded perspective view showing the waterproof container separated from the base structure, with the lid of the container pivoted open, with the view showing a flat central region of the base structure that is configured to underlie and support the container, and showing the left and right upstanding formations of the base structure and a left recess of the container, all of which are elements of the snap-together connection;

FIG. 7 is an enlarged left side elevational view of the waterproof container supported atop the central region of the base structure, with a thin sheet of magnetic material provided between a bottom surface of the central region and an exterior of a trunk lid atop which the base structure is positioned, with a U-shaped portion of the hook formation extending around an edge region of the trunk lid, and with an elongate strap shown foreshortened and connected to a short lower leg of the hook formation and extending beneath the trunk lid into an interior of the vehicle's trunk;

FIG. 8 is an enlarged sectional view as seen from a plane indicated by a line 8-8 in FIG. 7, showing the left upstanding formation of the base structure extending into the recess defined by the left upstanding end wall of the container which provide elements of the snap-together connection between the container and the base structure;

FIG. 9 is an enlarged but foreshortened sectional view showing front and rear portions of the water-proof container and the base structure;

FIG. 10 is a perspective view showing the top and right end portions of the waterproof container and showing how a hook formation of the base structure helps to hold the coupled container and base structure in place on a raised trunk lid; and,

FIG. 11 is an enlarged view showing interior portions of a raised trunk lid, with the view showing how an elongate strap that is connected to the short lower leg or the hook formation can extend along and attach to an interior covering of the trunk lid.

### DETAILED DESCRIPTION

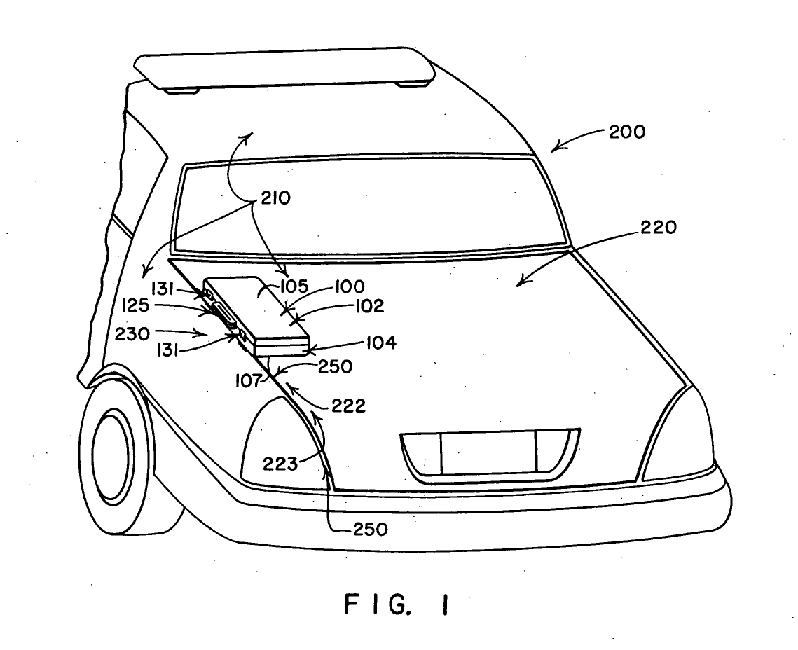

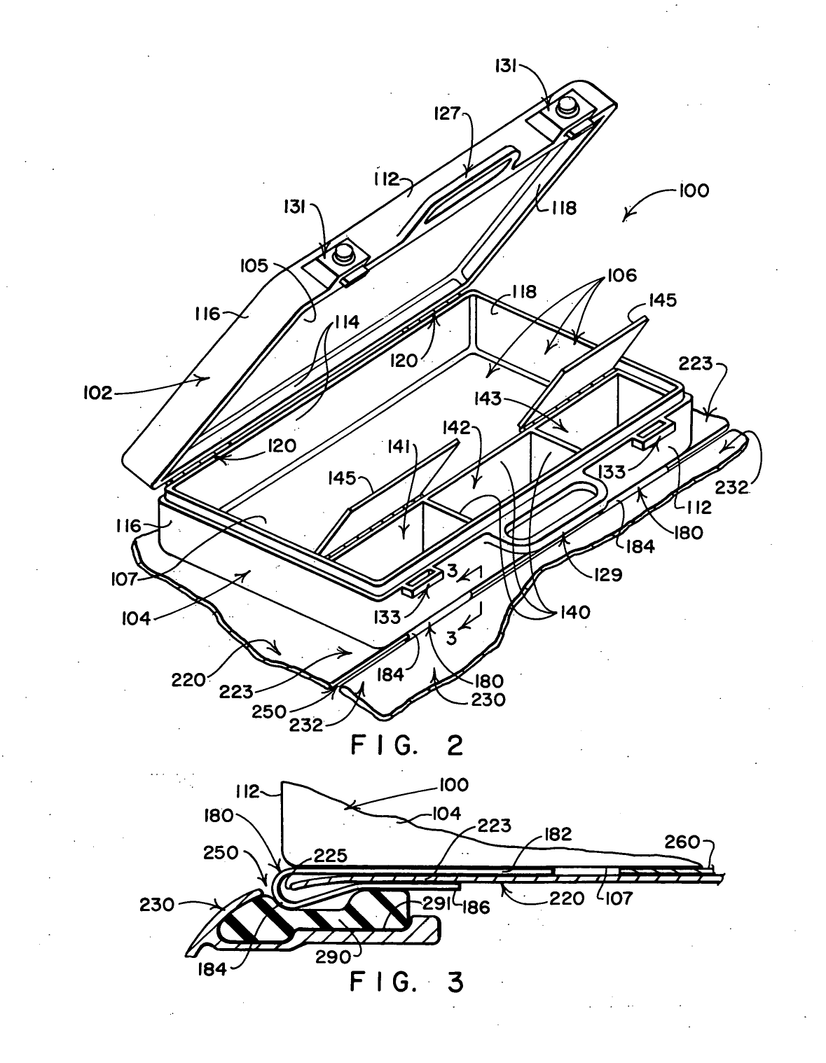

Referring to FIGS. 1 and 2, a waterproof container embodying features of the invention is indicated generally by the numeral 100. The waterproof container embodiment 100 also is described in the provisional application identified above.

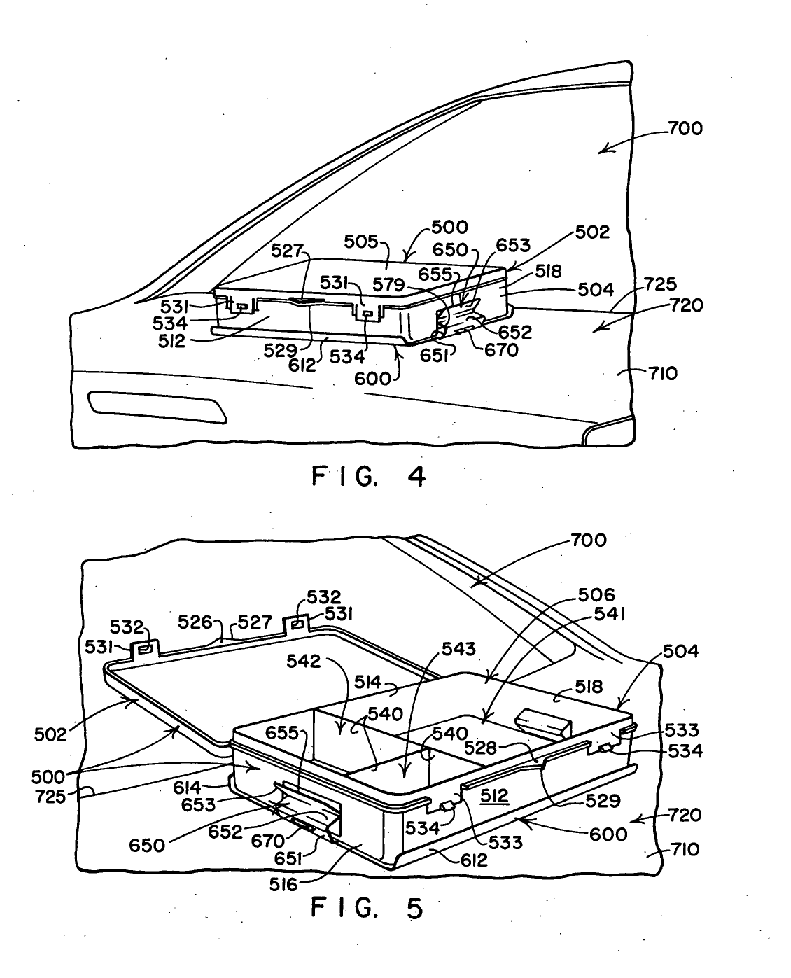

An enhanced and more preferred waterproof container embodiment 500 is shown in FIGS. 4-7 and 10. Features of the waterproof container embodiment 500, and of a base structure 600 that preferably is used to underlie and support the container embodiment 500, will be described later herein in conjunction with FIGS. 4-11.

In overview, each of the waterproof containers 100, 500 has a generally rectangular shape and is preferably about the size of a conventional hard-walled briefcase. Each is well suited to be releasably supported on the exterior of a lockable closure of a police vehicle or the like—typically atop a trunk lid of the vehicle so the container 100 or 500 is held conveniently at hand for use to receive and retain items collected from a person of interest who has been stopped during the course of a work shift of a police officer.

### The Waterproof Container 100

Referring to FIGS. 1 and 2, the container 100 has an upper component or lid 102, and a lower component or bottom 104 that are pivotally connected. The lid 102 can be pivoted between a closed position closely overlying the bottom 104 as shown in FIG. 1, and a raised or open position such as is shown in FIG. 2.

When closed, the lid 102 and the bottom 104 cooperate to define essentially an upper half 102 and a lower half 104, respectively, that surround and protectively enclose an interior or interior chamber 106 of the container 100. The interior 106 is of a size that is well suited to receive, contain, transport and store such pocket contents, personal possessions, weapons, contraband, evidence and other items as may be taken, collected or removed from the control of a person of interest who has been stopped or is being investigated, detained, frisked or arrested, such as often occurs during, in association with, or as the result of a vehicle stop or other law enforcement action.

In preferred practice, the upper and lower components 102, 104 of the container 100 preferably cooperate to mate and seal so as to render the container 100 waterproof when the lid 102 is closed. If desired, a resilient seal (not shown but typically of a type disclosed in U.S. Pat. No. 5,310,103 issued May 10, 1994—the disclosure of which is incorporated herein by reference) may be provided on or extending along such portions of one or both of the components 102, 104 as engage when the lid 102 is closed, so as to prevent the entry of water and other contaminants into the interior compartment or chamber 106.

When closed, the lid 102 of the container 100 cooperates with the bottom 104 to define top and bottom halves of a front wall 112, top and bottom halves of a rear wall 114, and top and bottom halves of opposed end walls 118, respectively, that extend between and connect top and bottom surface 105, 107, respectively, of the container 107—all of which are designated by reference numerals in FIG. 2. Conventional interactive latch elements 131, 133 are carried on the top and bottom halves 102, 104, respectively, of the front wall 112 of the container 100 for releasably retaining the lid 102 in the closed position shown in FIG. 1. If desired, the latch elements 131, 133 may provide a locking capability that can be operated by key (not shown) or by setting a combination, or both, as is well known to those who are skilled in the design and manufacture of security containers, briefcases, moneybags and the like.

In normal use, the waterproof container embodiment 100 is positioned atop an exterior surface 210 of a trunk lid 220 of a police vehicle 200 at a location relatively near to a thin rounded edge 225 of the trunk lid 220. When the trunk lid 220 of the vehicle 200 is closed, the thin, rounded edge 225 of the trunk lid extends along and adjacent or relatively near to a left rear fender portion 230 of the vehicle 200. A narrow space 250 of substantially uniform width separates the thin, rounded edge 225 of the trunk lid 220 from the left rear fender portion 230 of the vehicle 200.

To hold the container 100 in place on the trunk lid 220 near the trunk lid edge 225, two identical, generally U-shaped retaining clips 180 (also referred to herein as “hook formations” or “hook-shaped formations”) are connected to the container 100 at spaced locations along a front of the bottom surface 107 of the container 100, as is shown in FIG. 2. One of the identical retaining clips or hook formations 180 is depicted in FIG. 3.

The retaining clip or hook formation 180 shown in FIG. 3 has generally flat upper and lower legs 182, 186, respectively, that are connected by an integrally formed, U-shaped portion 184. The clip 180 is preferably formed from spring steel or other resilient material, and biases or clamps the top and bottom legs 182, 186 toward each other so the clip 180 serves to grip an edge region 223 of the trunk lid 220 therebetween.

When the retaining clips 180 are in use holding the container 100 in place on the trunk lid 220, the curved portions 184 the clips 180 extend through the narrow space 250 in a manner that is shown most clearly in FIG. 3. When the trunk lid 220 is closed, the proximity of the left rear fender portion 230 of the vehicle 220 to the thin rounded edge 225 of the trunk lid 220 (i.e., they are separated by only the narrow space 250) prevents the retaining clip or hook-shaped formation 180 from sliding off of the edge region of the trunk lid 220.

Stated more simply, when the trunk lid 220 is closed, the retaining clips or hook formations 180 hold the container 100 in place on the trunk lid 220.

To further assist in holding the container 100 in place on the exterior of the trunk lid 220, a relatively thin sheet of magnetic material 260 is preferably adhered to the bottom surface 107 of the container 100, as shown in FIG. 3. The magnetic material 260 attracts the steel from which the trunk lid 220 is formed.

To also assist in holding the container 100 in place on the exterior of the trunk lid 220, use can be made of a resilient strip of rubberized seal material 290 (FIG. 3) that typically is provided on an upwardly facing surface 291 of the vehicle fender 230 to prevent moisture from entering the interior of the trunk of the vehicle 200. The resilient character of the seal material 290 presses upwardly on bottom legs 323 of the clips 180 to assist the identical clips 180 in snugly gripping the edge region 223 of the trunk lid 220.

In accordance with a method of use that is described in the referenced provisional application, a plurality of the waterproof containers 100 that preferably are substantially identical are provided for use, one at a time, in receiving and retaining items collected from a sequence of persons of interest. Once items have been collected from one person of interest, an in-use container 100 that contains the collected items is closed and removed from the exterior of the vehicle 200, and an identical but empty replacement container 100 is installed on the exterior surface 210 so the replacement container is in position and ready to use to receive and retain items collected from a next person of interest. In this manner, a different container 100 is used to receive and retain items that are collected from each person of interest who may be stopped or detained during a shift of a police officer.

Although it is not necessary for the container 100 to be provided with a handle, one of the many types of conventional handle structures that can be provided on the container 100 is designated in FIG. 1 by the numeral 125. When the lid 102 of the container 100 is closed as shown in FIG. 1, the handle structure 125 is cooperatively defined by two similarly configured handle formations 127, 129 that engage and extend one atop another as they project forwardly from the top and bottom halves of the front wall 112 of the container 100.

In preferred practice, major portions of the containers 100, 500 are formed utilizing conventional techniques of injection molding of suitable thermoplastic materials that are selected to provide dimensional stability and durability during lengthy service lives, resistance to sunlight, wind, inclement weather, and common cleaning chemicals.

Parts, pieces, portions and components of the containers 100, 500 that are subjected to significant handling, or that are likely to loosen or wear with age or during lengthy service lives (such as two hinges 120 shown in FIG. 2 that pivotally connect the upper and lower halves 102, 104), may be formed from, or may have portions formed from stainless steel or other suitable materials that are selected to enhance wear resistance, longevity and other desirable characteristics.

Subdividing interior portions of the interior 106 to provide a plurality of relatively smaller compartments 141, 142, 143 (shown in FIG. 2) are dividers 140 that may be movable and repositionable, if desired. Selected ones of the compartments 141, 142, 143 may be provided with individual lids or covers 145 to aid in retaining contents within selected ones of the compartments 141, 142, 143.

As those who are skilled in the art will readily appreciate, although the container embodiment 100 is shown in FIG. 1 positioned on an exterior of a lockable trunk lid 220 near an edge region thereof, it is not essential that the container 100 be carried on a lockable closure of a police vehicle, or even on an exterior surface of a vehicle. Instead, the container 100 can, of course, be carried on a suitable interior portion of a vehicle or other structure at a location selected to be out of reach of persons of interest who are being questioned, detained or arrested.

### The Enhanced Waterproof Container 500 & Base Structure 600

As will be explained, in a preferred practice of the invention, enhanced containers of a type shown in FIGS. 4 and 5 are put to use, one at a time, when positioned one at a time atop and releasably snap-connected to a base structure 600. As will also be explained, in preferred practice, the base structure 600 is positioned atop and is releasably connected to a lockable closure of a police vehicle 700, most commonly atop an exterior surface 710 of a trunk lid 720 of the police vehicle 700, substantially in the manner shown in FIGS. 4 and 5.

As will be explained, a feature of the enhanced container embodiment 500 that yields a significant improvement over the container embodiment 100 is the provision of a snap-together connection that enables a sequence or series of the containers 500 to be quickly and easily connected, one at a time to, and disconnected quickly and easily from, the base structure 600. The snap-together connection mentioned above is preferably provided by interactive, engaging formations of the container 500 and the base structure 600 that enable one substantially identical container 500 after another to be positioned one at a time on and releasably connected to the base structure 600 and used to receive and retain items collected from a series or sequence of persons of interest—in much the same manner described previously that permits a series or sequence of preferably identical containers 100 to be used, one at a time, for substantially the same purpose.

The enhanced container 500 has an upper component or lid 502 that is pivotally connected to a lower component or bottom 504. The lid 502 and the bottom 504 cooperate, when the lid 502 is closed as shown in FIG. 4, to surround and protectively enclose an interior compartment 506 which is shown in FIG. 5. The lid 502 has an exterior that includes a flat, generally rectangular top surface 505. The bottom 504 has an exterior that includes a flat, generally rectangular bottom surface 507.

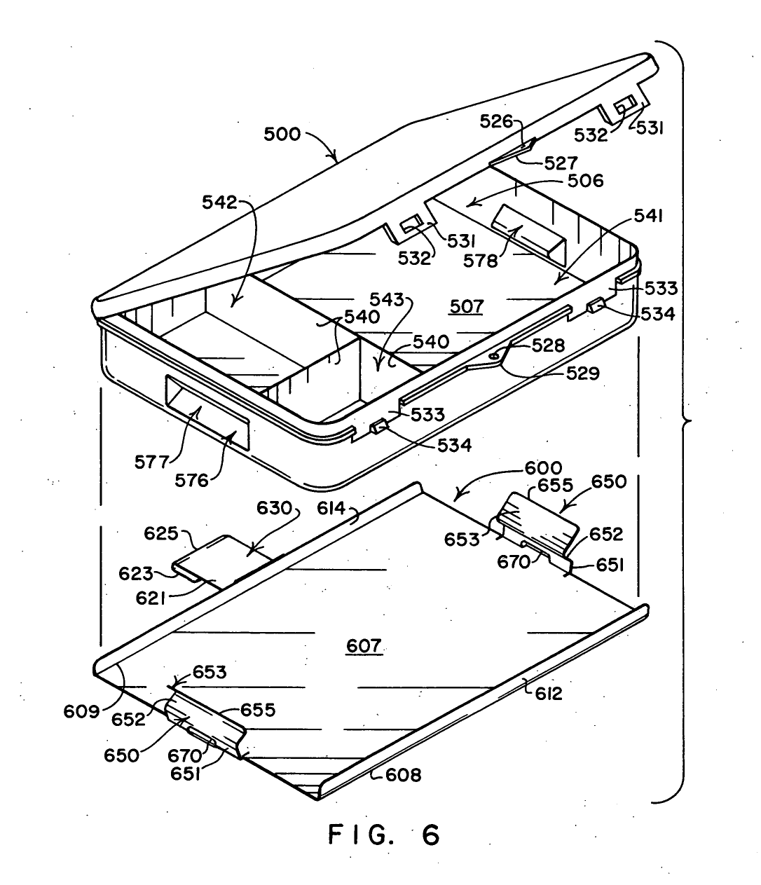

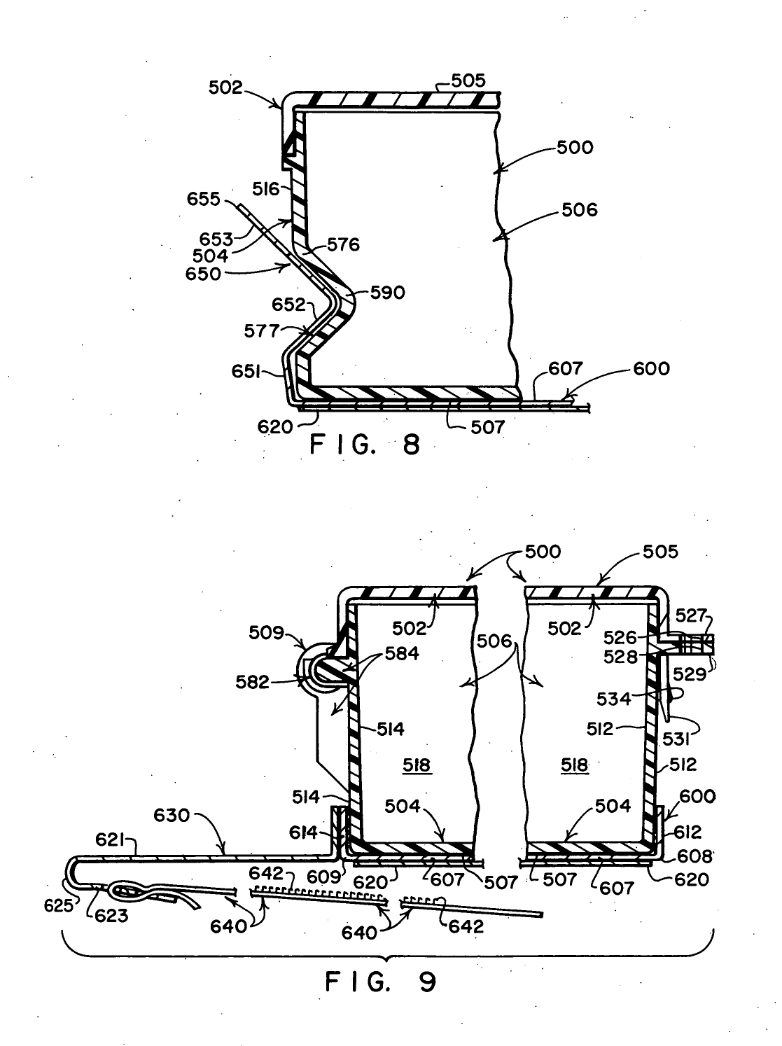

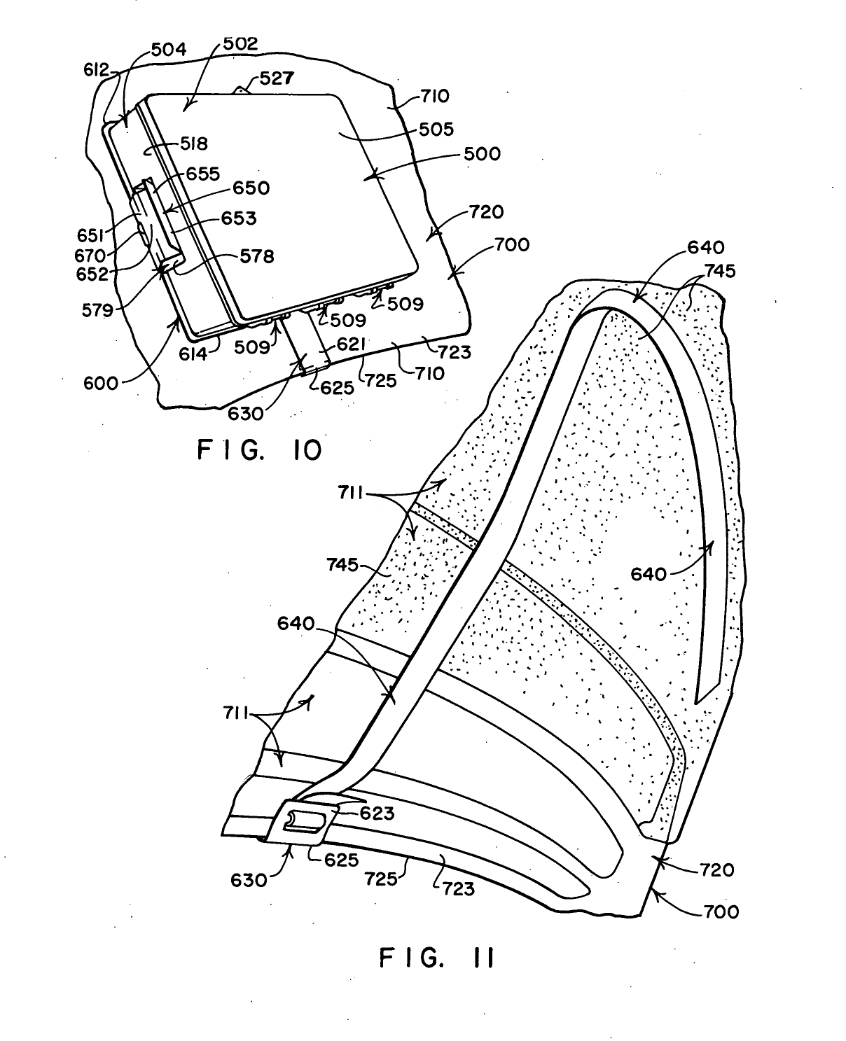

The pivotal of the lid 502 to the bottom 504 permits the lid 502 to move relative to the bottom 504 between the closed position shown in FIGS. 4 and 10, and such open positions as are shown in FIGS. 5 and 6. In the cross-sectional view provided by FIG. 9, a typical hinge structure 509 is shown that is formed by interfitting formations 582, 584 of the lid 502 and the bottom 504, respectively. Three of the hinge structures 509 are preferably utilized to couple the lid 502 and the bottom 504, as is shown in FIG. 10.

The interior compartment 506 of the enhanced container 500 is of a size that is well suited to receive, contain, transport and store such pocket contents, personal possessions, weapons, contraband, evidence and other items as may be taken, collected or removed from the control of a person of interest who has been stopped or is being investigated, detained, frisked or arrested, such as often occurs during, in association with, or as the result of a vehicle stop or other law enforcement action.

In preferred practice, the upper and lower components 502, 504 of the enhanced container 500 cooperate to mate and seal to render the enhanced container 500 waterproof when the lid 502 is closed. If desired, a resilient seal (not shown but typically of a type disclosed in U.S. Pat. No. 5,310,103 issued May 10, 1994—the disclosure of which is incorporated herein by reference) can be provided, on or extending along, such portions of one or both of the components 502, 504 as engage when the lid 502 is closed, to prevent the entry of water and other foreign matter into the interior compartment 506.

Conventional interengageable latch formations 531, 533 (best shown in FIG. 5) that are formed integrally with the lid and bottom 502, 504, respectively, are provided for releasably holding the lid 502 in the closed position shown in FIG. 1. The formations 531 on the lid 502 are provided with openings 532 through which projecting portions 534 of the formations 533 on the bottom 504 can extend to releasably hold the lid 502 closed.

In much the same way that the lid 102 and bottom 104 of the container 100 is provided with forwardly extending formations 127, 129 that cooperate when the lid 102 is closed to define a handle 125, the lid and bottom 502, 504, respectively, of the enhanced container 500 are provided with forwardly projecting formations 527, 529 that can cooperate (when the lid 502 of the container 500 is closed) to extend in overlying relationship and to define aligned holes 526, 528, respectively. The aligned holes (best seen in the enlarged sectional view of FIG. 8) can receive a conventional security seal (not shown) or a shackle of a conventional padlock (not shown) to ensure that the enhanced container 500 is not opened without proper authorization once the container 500 has been closed to retain items contained therein.

Whereas the container embodiment 100 has an interior 106 that is provided with a plurality of small individual compartments 141, 142, 143 some of which may be provided with individual lids 145, the enhanced container 500 preferably has an interior 506 that is subdivided by partitions 540 into three compartments 541, 542, 543 of differing sizes that all are closed by the lid 502 when the lid 502 of the container 500 is pivoted to the closed position shown in FIG. 4. When the lid component 502 is closed, the lid 502 also cooperates with an upstanding front wall 512, with an upstanding rear wall 514, and with opposed upstanding end walls 116, 118 to provide a waterproof seal that prevents moisture from entering into the interior 506 of the container 500.

In preferred practice, the largest in size of the compartments 541, 542, 543 is of a size that can receive and retain a handgun (not shown) of a size normally carried as a sidearm by police officers (and others who have a permit to carry)—with a size of about 8.5 by about 8.5 by about 2.5 inches being preferred. The smaller of the compartments 541, 542, 543 may, by example, take sizes of about 4 by about 6 by about 2.5 inches, and about 4 by about 2.5 by about 2.5 inches. Compartments of other sizes will be selected by members of the military and other governmental agencies who have containers 500 of various sizes provided to meet the needs and preferences of their officers.

Referring to FIGS. 5-8, the upstanding end wall 516 defines an elongate, centrally located, inwardly extending formation 576 that provides an outwardly opening recess 577. Referring to FIGS. 4-6, the opposite upstanding end wall 518 defines an identical, elongate, centrally located, inwardly extending formation 578 that provides an outwardly opening recess 579 which is identical to the recess 577.

Referring to FIG. 6, the base structure 600 is preferably formed from steel and has a flat, generally rectangular central region 607 that is of sufficient size to underlie the complete bottom surface 507 of the container 500, and to thereby support the container 500 atop the central region 607 of the base structure 600. Extending along substantially the full lengths of the front edge 608 and the rear edge 609 are short, upwardly turned front and rear walls 612, 614, respectively. When the container 500 is seated with the bottom surface 507 of the container 500 resting on the flat central region 607 of the base structure 600, the short, upwardly turned front wall 612 extends upwardly for a short distance along a lower portion of the front wall 512 of the container 500, and the short, upwardly turned rear wall 614 extends upwardly for a short distance along a lower portion the rear wall 514 of the container 500, as can be seen in FIGS. 4, 5 and 9.

Referring principally to FIG. 6, the previously mentioned snap-together connection that facilitates the easy and quick connection of the enhanced containers 500 one at a time to, and the equally quick and easy removal of containers 500 from, the base structure 600 results from the provision of upstanding formations that provide spring-like clips 650 which extend upwardly from opposite ends of the flat central region 607 of the base structure 600. The upstanding spring-like clips 650 have relatively short, vertically extending lower portions 651 that integrally connect with the central region 607 of the base structure 600 to support inwardly and outwardly turned legs 652, 653, respectively. The legs 652, 653, cooperate to define substantially V-shaped, inwardly extending formations 654 that are configured to be received snugly in the elongate, outwardly opening recesses 577, 579 that are defined by the left and right upstanding end walls 516, 518, respectively, of the container 500.

The outwardly turned upper legs 653 are longer than the inwardly turned, centrally-located legs 652, and have rounded upper end regions 655 that can be engaged by one's thumbs to deflect and thereby release the inwardly extending spring-like clips 650 from the outwardly opening recesses 577, 579 to quickly release a snapped-in-place container 500 from the base structure 600. The outwardly turned legs 653 can also be engaged by a container 500 (that is being lowered and pressed into position seated atop the central region 607 of the base structure 600) to outwardly deflect the spring-like clips 650 so the container 500 that is being pressed downwardly can be snapped into releasably retained engagement with the base structure 600 as the clips 650 enter the recesses 577, 579.

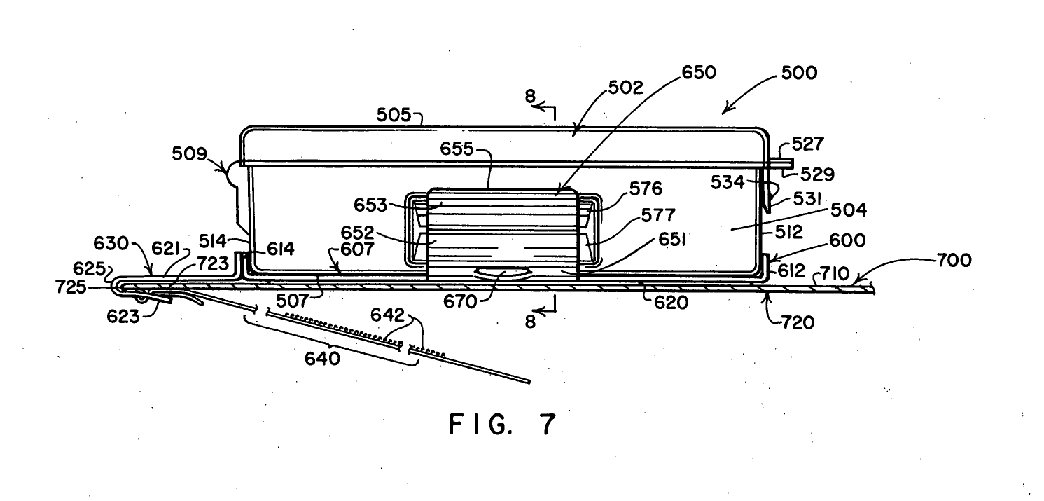

As is best shown in FIG. 7, at least one elongate opening or slot 670 is preferably formed through a lower part of each of the upstanding leg portions 651 of the spring-like clips 650 to relieve some of the resistance the spring-like clips 650 may naturally have to being resiliently deflected outwardly (i.e., away from each other) to quickly and easily release a snap-connected container 500 from being releasably retained by the base structure 600. The length and size of the openings or slots 670 can be selected to fine-tune the resilience of spring-like clips 650.

As those skilled in the art will readily understand and appreciate, such snap-together connections as are provided by the interaction and interengagement of the spring-like clips 650 and the container recesses 577, 579 can, of course, be provided by other types of interacting and interengaging formations (not shown).

In normal use, the base structure 600 is positioned atop and rests on the exterior surface 710 of a trunk lid 720 of a police vehicle 700 (as shown in FIG. 7) in much the same manner that the container 100 is shown positioned atop and resting on the exterior surface 210 of the trunk lid 220 of the police vehicle 200 in FIGS. 1 and 2.

More than one device may be (and preferably is) provided to releasably connect the base structure 600 to, and to retain the base structure 600 at a chosen location or position on the trunk lid 720. One preferred example of such a retaining device is a thin sheet of commercially available magnetic material 620 (shown in FIGS. 7-9) that underlies and is adhered to the flat, generally rectangular central region 607 (FIG. 6) of the base structure 600. The magnetic material 620 is magnetically attracted to steel used in the formation of the trunk lid 720.

A second preferred example of a retaining device for holding the base structure 600 in place on the trunk lid 720 is a hook structure 630 (shown in FIGS. 6 and 9-11) that has a long upper leg 621 that is connected to and reaches away from the base structure 600 to provide a curved, U-shaped end region 625 that wraps around an edge 725 of the trunk lid 720 and grips an edge region 723 of the trunk lid 720, as shown in FIGS. 7, 10 and 11.

A third preferred example of a retaining device for holding the base structure 600 in place on the trunk lid 720 is an elongate flexible strap 640 (shown in FIG. 11) that has an end region attached to a short lower leg 623 of the hook formation 630. The elongate strap 640 is positioned interiorly with respect to the trunk lid 720 and carries a multi-hook material 642 typically of a type sold under the registered trademark Velcro that can be releasably attached to, upon contact with, a fibrous or fuzzy lining 745 that commonly is provided by vehicle manufacturers to cover and soundproof internal surface portions of the trunk lid 720. If need be, a loop containing material (not shown) to which the multi-hook material 642 can be readily releasably attached can be provided on the interior of the trunk lid 720.

Although the containers 100, 500 may assume a wide variety of suitable sizes, a presently preferred size for the containers 100, 500 is about 13 to about 15 inches in length, by about 9 to about 10 inches in width, by about 2.4 to about 4 inches in depth. While containers 100, 500 which are generally rectangular in shape are preferable, those skilled in the art will recognize that advantages can result from rounding corner regions and modifying other portions of the containers 100, 500 to provide shapes that are well suited to receive and retain specific contents, including contents that are of unusual size or shape.

In designing containers that embody features of the present invention, it is preferable to enhance the ease with which the containers 100 and the base structures 600 can be quickly and easily releasably connected to and disconnected from the exterior of a lockable closure, and the desirability of providing connections that require minimal use of fasteners that penetrate the external surface of a lockable closure, such as the trunk lids 220, 720.

Although the invention has been described in its preferred form with a certain degree of particularity, it is understood that the present disclosure of the preferred form has been made only by way of example, and that numerous changes in the details of construction and the combination and arrangement of parts may be resorted to without departing from the spirit and scope of the invention. It is intended that such claims as may be presented in a subsequently filed utility patent application will protect whatever features of patentable novelty exist in the invention disclosed.

What is claimed is:

1. In combination, a waterproof container for containing items collected from a person of interest, and a base structure having a central region configured to underlie and support the container when the base structure is in a selected position on an exterior surface of a closure of a police vehicle, with the container and the base structure defining engageable formations configured to engage to releasably retain the container on the base structure with the central region underlying and supporting the container.

2. The combination of claim 1 wherein the engageable formations cooperate to define a snap-together connection with selected ones of the formations being resiliently deflectable to establish a connection between the container and the base structure, and to release the container from the base structure.

3. The combination of claim 1 wherein the engageable formations include upstanding formations of the base structure that are configured to be received in recess formations of the container.

4. The combination of claim 3 wherein the upstanding formations include two spaced-apart upstanding spring clips defined as integral elements of the base structure that each are configured to be snugly received in a different one of two spaced-apart recess formations formed in opposed, upstanding end walls of the container.

5. The combination of claim 1 additionally including means for releasably retaining the base structure in a selected position on an exterior surface of a lockable closure of a vehicle.

6. The combination of claim 5 wherein the means for releasably retaining the base structure includes magnetic material carried by a portion of the base structure that overlies the exterior surface of the lockable closure when the base structure is in the selected position.

7. The combination of claim 5 wherein the means for releasably retaining the base structure includes a hook formation connected to the base structure and configured to extend around an edge of the lockable closure.

8. The combination of claim 5 wherein the means for releasably retaining the base structure includes a hook formation connected to the base structure that is configured to extend through a space defined by the vehicle that is too narrow to permit withdrawal of the hook formation therethrough unless the lockable closure is pivoted to an open position.

9. The combination of claim 5 wherein the means for releasably retaining the base structure includes an elongate strap connected to the base structure, wherein the strap is configured to be connected to an interior portion of the vehicle when the base structure is in the selected position.

10. The combination of claim 1 wherein the container has a bottom wall and an upstanding sidewall that cooperates with the bottom wall to define a bottom component of the container, and wherein the container has a lid pivotally connected to the upstanding sidewall and defining a top portion of the container that can pivot between a closed position that overlies and cooperates with the bottom component to enclose and define a waterproof interior of the container, and an open position that permits the collected items to be introduced into the interior.

11. The combination of claim 10 wherein the lid and the upstanding sidewall having formations that engage when the lid is in the closed position and define aligned openings that can be used to retain the lid in the closed position.

12. The combination of claim 1 wherein the container is formed primarily from injection molded plastic material, and the base structure is formed primarily of steel.

13. In combination, a container having a bottom wall, an upstanding perimeter wall and a lid pivotally connected to the perimeter wall, with the lid being movable between positions that open and close the container so the container can receive items collected from a person of interest when the lid is open, and can retain the collected items when the lid is closed; a base structure configured to be positioned on an exterior surface of a lockable closure of a police vehicle, and to underlie, support and grip the container; with the base structure defining spaced, resilient, upstanding formations configured to receive the container therebetween, and to be briefly resilient deflected to provide a snap-together connection that enables the container to be received between and to be gripped by the resilient upstanding formations, and to be released from being received between and gripped by the resilient upstanding formations.

14. The combination of claim 13 additionally including retaining means for releasably retaining the base structure in a selected position on the exterior of the lockable closure of the police vehicle.

15. The combination of claim 14 wherein the retaining means includes magnetic material underlying and secured to a bottom surface of the base structure for attracting steel from which the lockable closure is formed.

16. The combination of claim 14 wherein the container is formed primarily from plastics material, and the base structure being formed primarily from steel.

17. The combination of claim 14 wherein the spaced upstanding formations of the base structure define resilient spring clips that extend into oppositely opening recesses of the container.

18. The combination of claim 14 wherein the base structure defines an elongate hook formation configured to extend around an edge region of the lockable closure.

19. In combination, a base structure positionable on and releasably connectible to an upwardly facing exterior surface of a lockable metallic closure of a police vehicle, and an upwardly opening lidded container positionable on and releasably connectible to the base structure, with the base structure being provided with magnetic material for helping to retain the base structure at a selected location on the exterior surface, and with the container and the base structure having interfitting formations that are engageable to retain the container on the base structure.

20. The combination of claim 19 wherein the interfitting formations define a snap-together connection that permits the container to be quickly and easily attached to and removed from the base structure.

22. In combination, an upwardly opening generally rectangular container configured to receive items collected from a person of interest, a base structure configured to underlie and support the container, first connection means including engageable formations of the base structure and the container capable of establishing a snap-together connection for releasably retaining the container supported atop the base structure, a lid connected to the container for pivotal movement between an open position that permits the collected items to be inserted into and removed from the container while the container is supported atop the base structure, and a closed position overlying and closing the container to retain the collected items in the container, and second connection means for releasably connecting the base structure to a lockable closure of a police vehicle.
